(19) United States
(12) Patent Application Publication
(10) Pub. No.: US 2012/0023825 A1
(43) Pub. Date: Feb. 2, 2012

(54) WATERTIGHT PATIO DOOR ASSEMBLY

(75) Inventor: Normand LABRECQUE, Beloeil (CA)

(73) Assignee: GROUPE LESSARD INC., Dorval (CA)

(21) Appl. No.: 13/165,127

(22) Filed: Jun. 21, 2011

Related U.S. Application Data
(60) Provisional application No. 61/369,952, filed on Aug. 2, 2010.

(30) Foreign Application Priority Data
Jul. 30, 2010 (CA) 2710278

(51) Int. Cl. E06B 7/16; E05D 15/06; E06B 7/14; E06B 3/46

(52) U.S. Cl. 49/130; 49/408; 49/506; 52/656.4

(57) ABSTRACT

The watertight patio door assembly includes two adjacent and laterally offset door panels mounted in a door frame, at least one of the door panels being slidably movable within the door frame. It also includes a combined air and water passageway located within a sill section of the door frame. The passageway provides a continual fluid communication between a location at a bottom end of a clearance gap, located between adjacent vertical frame members of the door panels when the patio door assembly is closed, and the exterior side of the patio door assembly. Two spaced-apart sets of weatherstrips create a vertically-extending buffer air space within the clearance gap. The disclosed arrangement can greatly improve watertightness between the door panels during severe weather conditions without the need of a complex arrangement and/or weatherstrips impairing the movement of the sliding door panel or panels. A method for improving watertightness between a sliding door panel and of a stationary door panel of a patio door assembly is also presented.

### CROSS-REFERENCE TO RELATED APPLICATIONS

The present case claims priority to Canadian Patent Application No. 2,710,278 filed 30 Jul. 2010 and to U.S. Provisional Patent Application No. 61/369,952 filed on 2 Aug. 2010. The entire contents of Canadian Patent Application No. 2,710,278 and of U.S. Provisional Patent Application No. 61/369,952 are incorporated herein by reference in their entirety.

### TECHNICAL FIELD

The technical field generally relates to patio door assemblies and more particularly to patio door assemblies having an improved watertightness between two adjacent door panels.

### BACKGROUND

A patio door assembly generally comprises two or more door panels disposed parallel to one another and that are mounted in a door frame. At least one of the door panels is slidably movable with reference to an adjacent and laterally offset door panel. Often, a patio door assembly comprises two door panels, one being slidable and the other being fixed (stationary) within the door frame. Many other different configurations exist, however. For instance, a patio door assembly can have more than two door panels.

One of the performance ratings for a patio door assembly is its resistance to rain water infiltrations from the exterior side to the interior side under severe weather conditions involving heavy rain and high winds when it is in a closed position. One of the main challenges for the designers of a patio door assembly attempting to obtain the highest possible rating is to mitigate the water infiltration between two door panels. The vertically-extending clearance gap located between the innermost vertical frame members of the door panels creates a possible entryway for water.

Generally, one or more weatherstrips are provided to mitigate air and water infiltrations through the clearance gap. However, during severe weather conditions, high winds impinging on the door panels can increase the air pressure on the exterior side, thereby creating a pressure differential between the exterior side and the interior side of the patio door assembly. This pressure differential can increase the risks of having water infiltrations from the clearance gap as water tends to be pushed towards the interior side. The bottom area of the clearance gap is particularly prone to water infiltrations since rain water flowing down along the inward door panel during a rain storm can result in a constant presence of water at that location. When combined to an air pressure differential, preventing water infiltrations during severe weather conditions can be difficult to achieve.

Attempts have been made in the past to mitigate water infiltrations from the clearance gap by providing better weatherstrips, often weatherstrips subjected to a more intense compression force when the patio door assembly is closed. This, however, is generally detrimental to the easiness of opening and closing the door panel or panels. These weatherstrips are also more prone to wear and may lose their efficiency over time.

Overall, room for improvements thus exists in this area.

### SUMMARY

In one aspect, there is provided a watertight patio door assembly having an exterior side and an interior side, the patio door assembly including: a quadrilateral door frame having a sill section, a head section and opposite first and second jamb sections; two adjacent and laterally offset door panels mounted in the door frame and lying in respective vertical planes that are parallel to one another, at least one of the door panels being slidably movable within the door frame, each door panel including vertical and horizontal frame members, the innermost vertical frame members of the door panels being adjacent to one another and having a clearance gap between them when the patio door assembly is in a closed position; a combined air and water passageway located within the sill section of the door frame, the passageway providing a continual fluid communication between a location at a bottom end of the clearance gap and the exterior side of the patio door assembly; and two spaced-apart sets of weatherstrips creating a vertically-extending buffer air space within the clearance gap, the buffer air space being immediately above the location at the bottom end of the clearance gap, a first one of the two sets of weatherstrips being proximal to an exterior edge of the clearance gap and being continually subjected to a substantially equal air pressure on opposite sides, any water reaching inside the buffer air space being channeled directly into the passageway and kept away from a second one of the two sets weatherstrips, which second set is distal from the exterior edge of the clearance gap.

In another aspect, there is provided an insert for use in a main section of a top-opened gutter extending longitudinally inside a sill section of a patio door frame, the insert including: a first elongated wall having a width substantially corresponding to the width inside of the main section of the gutter, the first wall including a notch made across a thickness of the first wall and extending widthwise adjacent to one end of the insert; and at least two spaced-apart second elongated walls extending perpendicularly from a first main face of the first wall, at least one of the second walls crossing the notch made through the first wall.

In another aspect, there is provided a method for improving watertightness between a sliding door panel and of a stationary door panel of a patio door assembly, the method including the simultaneous steps of: blocking at least some of the air and water using a first set of weatherstrips positioned adjacent to an inlet of a vertically-extending clearance gap located between adjacent vertical frame members of the door panels when the sliding door panel is in a closed position; maintaining a substantially equal air pressure on opposite sides of the weatherstrips of the first set when a pressure differential occurs between an interior side and an exterior side of the patio door assembly; and draining water toward the exterior side if any water passes through the first set of weatherstrips, the water being prevented from reaching a second set of weatherstrips located deeper into the clearance gap.

Further details on these aspects as well as other aspects of the proposed concept will be apparent from the following detailed description and the appended figures.

### BRIEF DESCRIPTION OF THE FIGURES

FIG. 1 is an elevation view illustrating an example of a patio door assembly depicting the proposed concept.

FIG. 2 is an enlarged isometric view of the bottom center area of the patio door assembly shown in FIG. 1.

FIG. 3 is a cross-section view taken along line 3-3 in FIG. 1.

FIG. 4 is a view similar to FIG. 1 showing the sliding door panel in a partially opened position.

FIG. 5 is a cross-section view taken along line 5-5 in FIG. 4.

FIG. 6 is an isometric view illustrating a portion of the bottom horizontal gutter shown in FIG. 5.

FIG. 7 is a cross-section view taken along line 7-7 in FIG. 4.

FIG. 8 is a cutaway view of some of the parts shown in FIG. 2.

FIG. 9 is an isometric view of the insert shown in FIG. 8.

### DETAILED DESCRIPTION

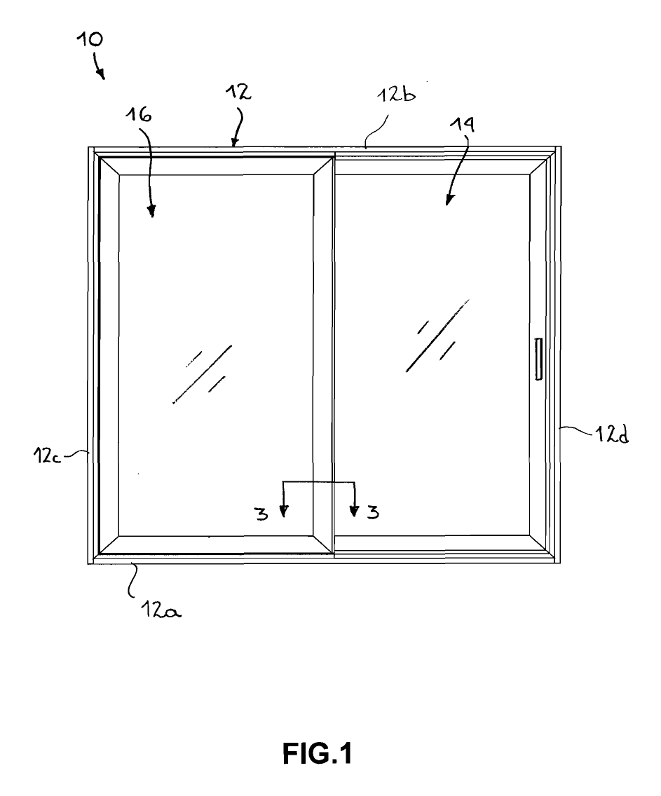

FIG. 1 is an elevation view illustrating an example of a patio door assembly 10 depicting the proposed concept. This patio door assembly 10 is designed for use in an opening between the interior side and the exterior side of a building. FIG. 1 illustrates the patio door assembly 10 as viewed from the exterior side of the building. The patio door assembly 10 includes a quadrilateral door frame 12. The door frame 12 includes a sill section 12a, a head section 12b and opposite first and second jamb sections 12c, 12d. The lengthwise direction of the sill section 12a and the head section 12b of the door frame 12 define what is referred to hereafter as the longitudinal direction of the patio door assembly 10.

The illustrated patio door assembly 10 includes only two door panels, one being a sliding door panel 14 and the other being a stationary door panel 16. Other configurations and arrangements are possible as well. For instance, it is possible to construct a patio door assembly where the two door panels are slidable. It is further possible to construct a patio door assembly with three or more door panels. If desired, one or more of the door panels can tilted and/or otherwise moved with reference to an adjacent door panel in addition to a sliding movement. These are only a few examples of possible alternative configurations and arrangements for the patio door assembly.

Each door panels 14, 16 includes vertical and horizontal frame members inside which is positioned a windowpane. If desired, one or more of the windowpanes can be replaced by another kind of sheet or structure, whether transparent, translucent or opaque.

The sliding door panel 14 and the stationary door panel 16 are adjacent and laterally offset. They lie in respective vertical planes that are parallel to one another. The stationary door panel 16 is closer to the exterior side than the sliding door panel 14 in the illustrated example. The sliding door panel 14 is movable within the door frame 12 between a closed position and an opened position. In the illustrated example, both door panels 14, 16 have substantially the same dimensions and are slightly longer than half of the distance between the first and the second jamb sections 12c, 12d. They thus slightly overlap at the center of the door frame 12.

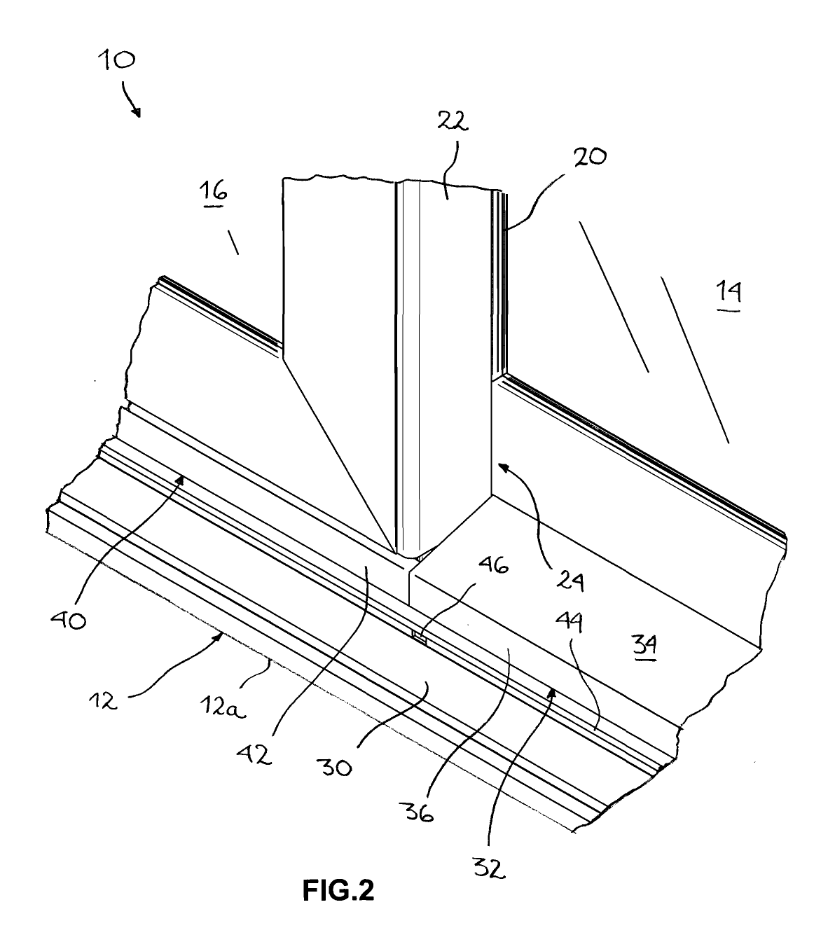

FIG. 2 is an enlarged isometric view of the bottom center area of the patio door assembly 10 shown in FIG. 1. As shown in FIG. 2, the innermost vertical frame members of the door panels 14, 16, which are identified using reference numerals 20, 22, respectively, are adjacent to one another when the sliding door panel 14 is in a closed position. The innermost vertical frame members 20, 22 are separated from one another by a vertically-extending clearance gap 24.

The sill section 12a of the door frame 12 includes an exterior sill member 30. The exterior sill member 30 extends in-between the jamb sections 12c, 12d of the door frame 12. The exterior sill member 30 can be manufactured from an extruded workpiece, for instance a workpiece made of aluminum. A first exterior capping member 32 is connected over the exterior sill member 30 in front of the sliding door panel 14. The first exterior capping member 32 extends between the innermost side of the stationary door panel 16 and the second jamb section 12d of the door frame 12. It includes an inclined upper wall 34 and a front wall 36. The upper wall 34 is inclined to redirect rain water away from the sliding door panel 14.

A second exterior capping member 40 located below the stationary door panel 16 is also connected to the exterior sill member 30. The second exterior capping member 40 extends between the innermost side of the stationary door panel 16 and the first jamb section 12c of the door frame 12. The second exterior capping member 40 has a front wall 42 that is positioned flush with reference to the front wall 36 of the first exterior capping member 32.

Also shown in FIG. 2 is an upstanding screen rail 44 provided for the sliding screen (not shown). The screen rail 44 is made integral with the exterior sill member 30 and extends uninterruptedly between the first and the second jamb section 12c, 12d. In the illustrated example, the screen rail 44 also includes a plurality of spaced-apart drain holes 46, one of which is shown in FIG. 2. The drain holes 46 provide a passage for draining water present behind the screen rail 44 toward the exterior side.

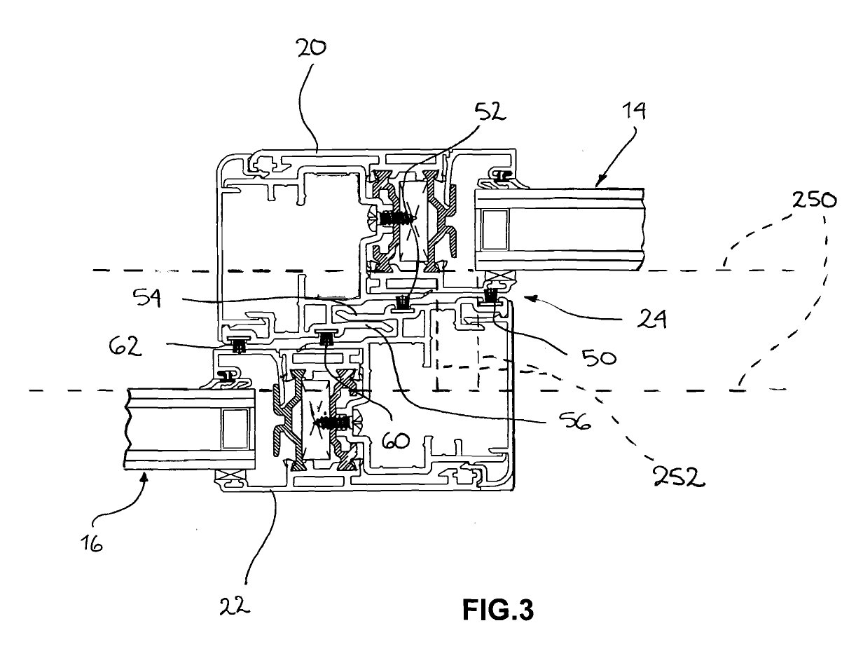

FIG. 3 is a cross-section view taken along line 3-3 in FIG. 1. It shows that two spaced-apart and vertically-extending weatherstrips 50, 52 are provided between the corresponding surfaces of the innermost vertical frame members 20, 22 of the door panels 14, 16.

In the illustrated example, both weatherstrips 50, 52 are connected to the innermost vertical frame member 22 of the stationary door panel 16. They engage the corresponding surface on the innermost vertical frame member 20 of the sliding door panel 14 when it is in a closed position. The first weatherstrip 50 is proximal to the exterior edge of the clearance gap 24. It mitigates air and water infiltrations under most weather conditions. The second weatherstrip 52 is positioned deeper in the first half of the clearance gap 24. Two vertically-extending flanges 54, 56, one provided on the sliding door panel 14 and one on the stationary door panel 16, cooperate with one another to close the clearance gap 24 at its center when the sliding door panel 14 is closed. Two spaced-apart and vertically-extending weatherstrips 60, 62 are provided between the two door panels 14, 16 in the second half of the gap 24. Other configurations and arrangements are possible as well.

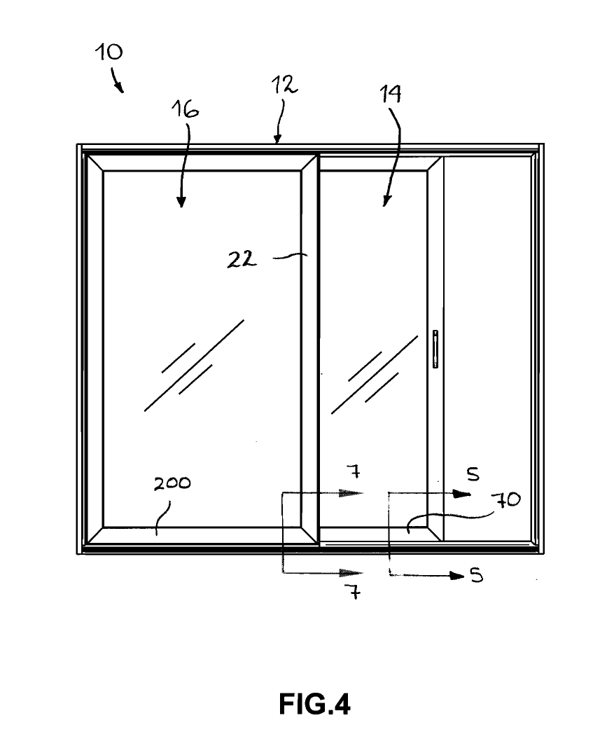

FIG. 4 is a view similar to FIG. 1 showing the sliding door panel 14 in a partially opened position. FIG. 4 shows the patio door assembly 10 as viewed from the exterior side of the building.

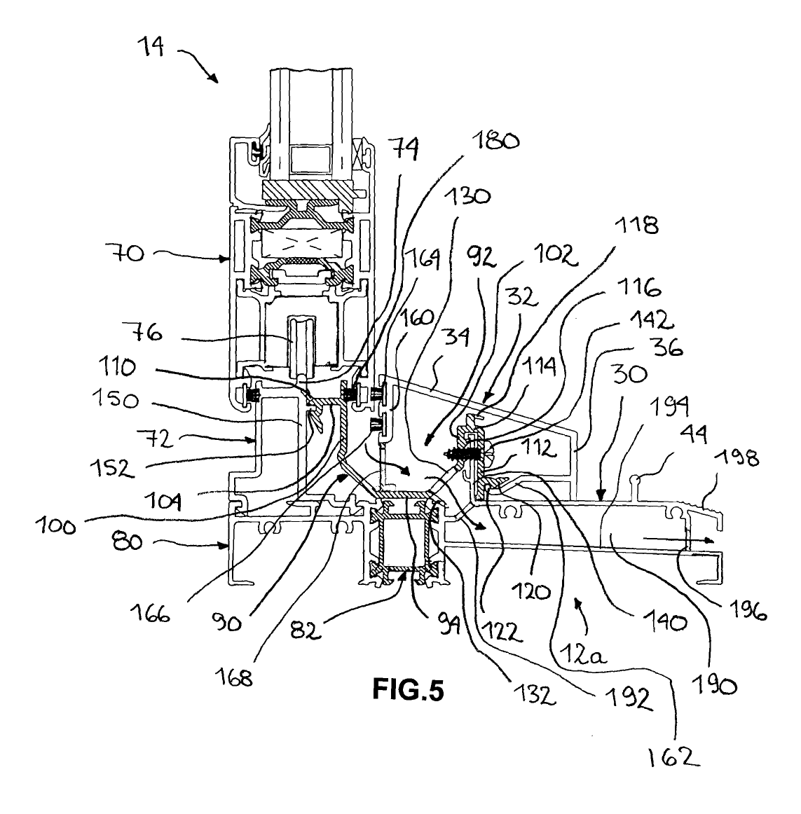

FIG. 5 is a cross-section view taken along line 5-5 in FIG. 4. It shows details of the bottom horizontal frame member 70 of the sliding door panel 14 and the sill section 12a of the door frame 12. The exterior side of the building is on the right side of the figure.

The sill section 12a of the door frame 12 includes an interior rail member 72 providing a track 74 for the sliding door panel 14. The sliding door panel 14 engages the top of the track 74 using two or more spaced-apart supporting wheels 76.

In the illustrated example, the interior rail member 72 is connected to an interior frame member 80 located at the bottom of the sill section 12a of the door frame 12. The interior frame member 80 is connected to the exterior sill member 30 using a thermal barrier 82. The thermal barrier 82 is made of a material having good mechanical properties and a thermal conduction coefficient lower than that of the materials it connects together. For instance, the thermal barrier 82 can be made of a polymer such as polyvinyl chloride while the exterior sill member 30 and the interior frame member 80 can be made of a metal such as aluminum. Other materials can be used as well.

Also visible in FIG. 5 is a bottom horizontal gutter 90 that is positioned in the sill section 12a of the door frame 12 immediately above the thermal barrier 82. The gutter 90 extends longitudinally from one side of the door frame 12 to the other. The gutter 90 has a main section 92 that is opened on the side opposite the thermal barrier 82. Similar gutters are also provided in the head section 12b and in the jamb sections 12c, 12d of the door frame 12, each having a main section opened towards the inside of the door frame 12.

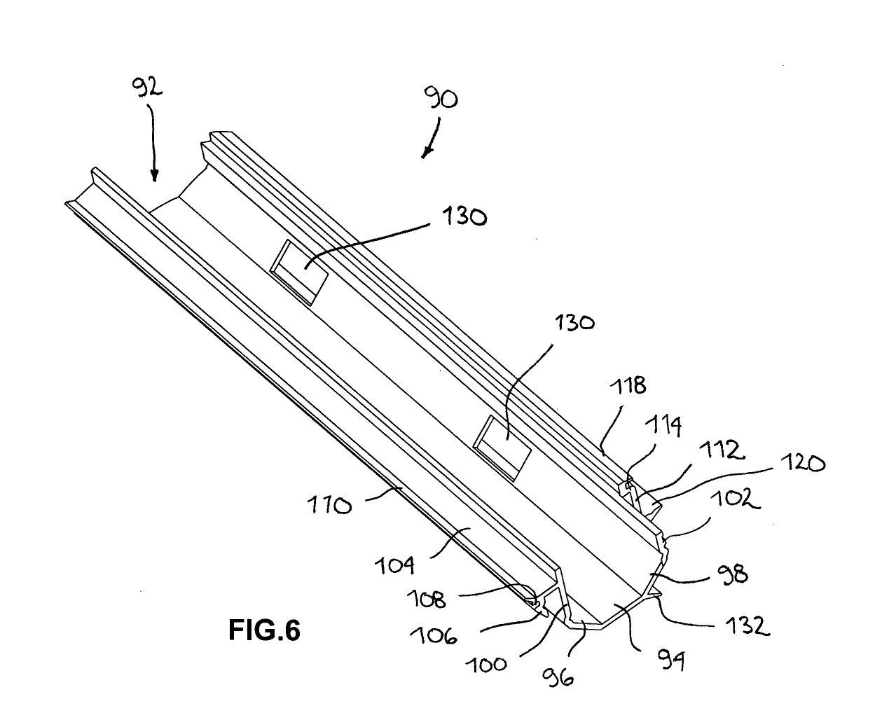

FIG. 6 is an isometric view illustrating a portion of the bottom horizontal gutter 90 shown in FIG. 5. The actual gutter 90 would be much longer than what is illustrated in FIG. 6. This figure also shows the gutter 90 from the end located near the first jamb section 12c of the door frame 12. A small portion at the end of the gutter 90 was machined to fit with the abutting end of the corresponding vertical gutter (not shown) located in the first jamb section 12c. The gutter 90 can be made of a material having a relatively low thermal conduction coefficient but relatively good mechanical properties. It can be made for instance of a polymer such as polyvinyl chloride. It can also be manufactured using an extrusion process and then machined thereafter. Other materials and manufacturing methods are also possible as well.

As shown in FIGS. 5 and 6, the main section 92 of the illustrated gutter 90 is somewhat U-shaped. It includes a bottom horizontal wall 94, two obliquely-disposed walls 96, 98, each being made integral with a corresponding longitudinal edge of the bottom horizontal wall 94, and two vertical walls 100, 102, each being made integral with a corresponding edge of one of the obliquely-disposed walls 96, 98. A horizontal flange 104 is made integral with the vertical wall 100 on the interior side of the illustrated gutter 90. A bottom member 106 is made integral with the horizontal flange 104 and creates a longitudinally-extending groove 108 facing the interior side. An upper flexible strip 110 is also made integral with the horizontal flange 104. This upper flexible strip 110 can be made for instance of polyvinyl chloride that is softer than the rest of the gutter 90. Other materials and configurations are possible.

Another vertical wall 112 is provided on the exterior side of the illustrated gutter 90, as best shown in FIG. 5. This vertical wall 112 is made integral with the upper edge of the adjacent vertical wall 102 through a horizontal bridge wall 114. Both adjacent vertical walls 102, 112 are spaced apart from one another. A small longitudinally-extending protrusion 116 is provided on a side of the vertical wall 102 facing the vertical wall 112. An upwardly-projecting flange 118 is also made integral with the horizontal bridge wall 114. This upwardly-projecting flange 118 supports a flexible strip projecting towards the exterior side. A horizontal flange 120 is made integral with the exterior side of the vertical wall 112, near the bottom edge thereof. This horizontal flange 120 includes a bottom groove 122 located immediately adjacent to the vertical wall 112.

A plurality of spaced-apart and square-shaped bottom drain holes 130 is provided through the obliquely-disposed wall 98 on the exterior side of the illustrated gutter 90. The lower edge of the bottom drain holes 130 is positioned about the upper surface of the horizontal bottom wall 94. This way, any water present therein can immediately exit the gutter 90 through one or more of the bottom drain holes 130. There is also an exterior water guiding plate 132 made integral with the rest of the gutter 90 at the junction between the bottom horizontal wall 94 and the obliquely-disposed wall 98. The water guiding plate 132 is configured and disposed to prevent water flowing out of the bottom drain holes 130 from reaching the thermal barrier 82, as best shown in FIG. 5.

As can also be seen from FIG. 5, the gutter 90 is snap-fitted over an upstanding flange 140 of the exterior sill member 30. The flange 140 fits inside the space formed between the two vertical walls 102, 112 on the exterior side of the illustrated gutter 90. The horizontal protrusion on the vertical wall 102 engages an abutment point at the tip of the flange 140. The parts are also connected together by a plurality of spaced-apart screws 142, one of which is shown in FIG. 5. On the left side of the illustrated gutter 90, the free end of the horizontal flange 104 engages the side of a vertical wall 150 of the interior rail member 72. This vertical wall 150 includes a small lateral projecting flange 152 that is made integral therewith. This small lateral projecting flange 152 fits into the groove 108 (FIG. 6) and the upper flexible strip 110 engages the surface of the vertical wall 150 above the flange 152.

FIG. 5 also shows the first exterior capping member 32 that is connected to the exterior sill member 30 in front of the sliding door panel 14. The bottom edge of its front wall 36 rests on the upper surface of the exterior sill member 30. The first exterior capping member 32 further includes a rear horizontal wall 160 and an interior wall 162. The interior wall 162 is made integral with the back of the front wall 36. It has its free end designed to be inserted inside the bottom groove 122 on the exterior side of the gutter 90.

The rear wall 160 of the first exterior capping member 32 includes an upper wall portion with two parallel horizontal grooves, each designed for receiving a corresponding weatherstrip 164, 166. It also includes a bottom wall portion 168 engaging the upper surface of the bottom horizontal wall 94 of the gutter 90. The bottom wall portion 168 includes a plurality of openings provided along its length to allow water passing from one side to the other.

As can be seen in FIG. 5, the vertical wall 100 on the interior side of the main section 92 of the gutter 90 is positioned under the sliding door panel 14 in the patio door assembly 10. The top edge of this vertical wall 100 is also slightly higher than the lowermost edge of the bottom horizontal frame member 70 of the sliding door panel 14. A weatherstrip 180 is provided between this lowermost edge and the interior side of the vertical wall 100 of the gutter 90. This weatherstrip 180 mitigates air infiltrations from inside the gutter 90 to the space located right under the sliding door panel 14.

As can be seen, any rain water flowing down along the exterior side of the sliding door panel 14 will tend to enter by gravity between the bottom horizontal frame member 70 and the rear wall 160 of the first exterior capping member 32. The weatherstrip 164, however, mitigates this water infiltration since it extends across the gap and redirects water over the top inclined wall 34 of the first exterior capping member 32. Nevertheless, if some rain water passes the weatherstrip 164, it will fall into the gutter 90.

In the illustrated example, the lowermost edge of the bottom horizontal frame member 70 of the sliding door panel 14 includes a bottom drip projection designed to form water drops and mitigates the risks that water reaches the weatherstrip 180 located under the sliding door panel 14 through a capillary action or the like. The water drops will also tend to contact the second weatherstrip 166, either as the water drops form or as the water drops fall.

As best shown in FIG. 5, any water present inside the gutter 90 will be directed to the bottom drain holes 130 on its exterior side and will eventually enter a chamber 190 located within the exterior sill member 30 through holes 192 located adjacent to the upstanding flange 140. As aforesaid, the water guiding plate 132 prevents the water from reaching the thermal barrier 82 as it exits the gutter 90 through its holes 130. Once inside the chamber 190 of the exterior sill member 30, water flows towards the exterior side of the sill section 12a since the bottom wall 194 of the chamber 192 is designed with a slight inclination. Water exits the chamber 190 through one or more outlet drain holes 196. In the illustrated example, the outlet drain holes 196 are hidden under an L-shaped flange 198 extending above them. This configuration improves the visual aspect of the patio door assembly 10 but also mitigate the tendency of water flowing over the exterior sill member 30 to enter the chamber 190 at the outlet drain holes 196. Other configurations and arrangements are possible as well.

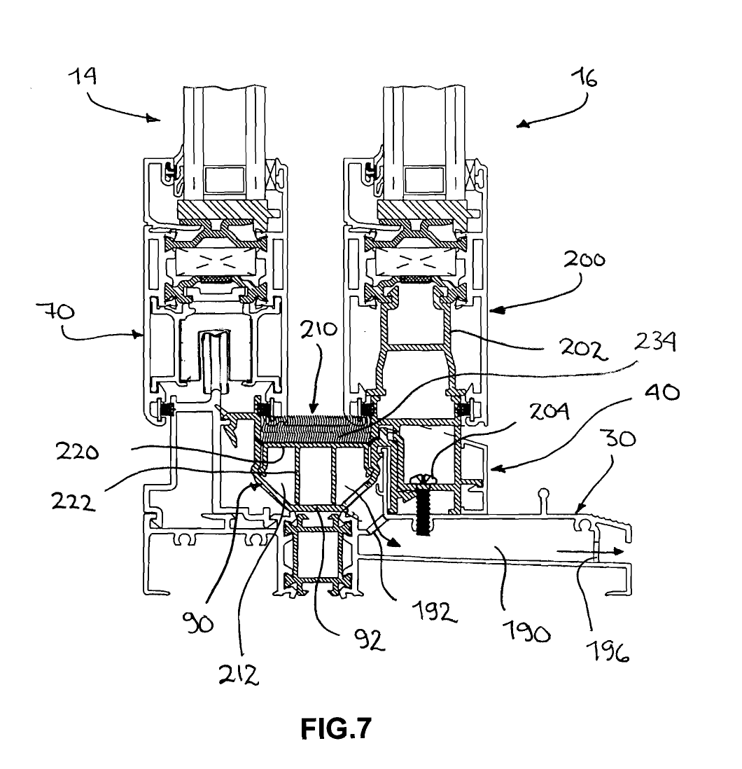

FIG. 7 is a cross-section view taken along line 7-7 in FIG. 4. It shows the details of the bottom horizontal frame member 200 of the stationary door panel 16. The exterior side of the building is on the right side of the figure. This figure shows many of the parts that are shown in FIG. 5, including the gutter 90 and the exterior sill member 30. It also shows how the stationary door panel 16 is connected to the door frame 12 in the illustrated example. The stationary door panel 16 includes a bottom frame extension 202 located under its bottom horizontal frame member 200. The bottom frame extension 202 overlaps the exterior side of the main section 92 of the gutter 90 and engages the upper surface of the exterior sill member 30. A plurality of screws 204 is provided between the bottom frame extension 202 and the exterior sill member 30.

As can be seen from FIG. 7, the exterior side of the main section 92 of the gutter 90 is positioned under the stationary door panel 16. The interior side of the stationary door panel 16 is within the interior of the building. Since the inside of the main section 92 of the gutter 90 is in continual fluid communication with the exterior side of the patio door assembly 10 through the bottom drain holes 130, the chamber 190 and its opposite holes 92, 196, the top of the main section 92 of the gutter 90 all along the stationary door panel 16 is closed by an insert 210. This way, air from the exterior cannot enter directly inside the building. The insert 210 has a length substantially corresponding to the length of the stationary door panel 16. The insert 210 seals a bottom space 212 inside the main section 92 of the gutter 90 from the interior of the building. However, air and water are still able to circulate within the bottom space 212 under the insert 210.

In the illustrated example, the insert 210 includes a main wall 220 and four spaced-apart elongated spacer walls 222 connected to the main wall 220, two being on the sides and two being near the center. The bottom edges of the spacer walls 222 near the center engage the bottom of the main section 92 of the gutter 90 when the insert 210 is connected thereto. The insert 210 engages the gutter 90 with a light interfering engagement.

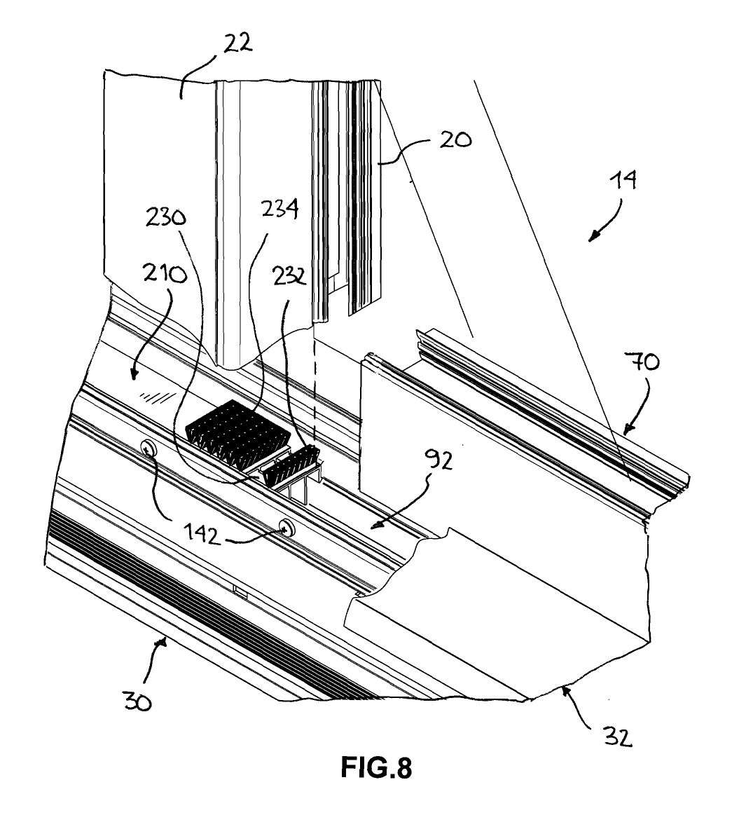

FIG. 8 is a cutaway view of some of the parts shown in FIG. 2. The insert 210 ends at the location shown in FIG. 8. FIG. 8 illustrates that the main wall 220 of the insert 210 includes a notch 230 extending transversally across the entire width of the main wall 220. This notch 230 is longitudinally positioned adjacent to the innermost end of the insert 210, leaving only a small portion of the main wall 220 at the end. This small wall portion is wider in a widthwise direction than in a longitudinal direction with reference to the insert 210.

The illustrated insert 210 further includes two upwardly-projecting weatherstrips 232, 234, each extending substantially horizontally on a respective side of the notch 230. In the illustrated example, the weatherstrip 234 is larger than the weatherstrip 232. The weatherstrip 232 includes one row of flexible pile fibers. The weatherstrip 234 includes a plurality of rows of flexible pile fibers. Other configurations and arrangements are possible as well.

Referring back FIG. 3, the stippled lines 250 extending parallel to the door panels 14, 16 show the approximate location of the longitudinal sides of the main section 92 of the bottom horizontal gutter 90. The stippled lines 252 show the approximate location of the notch 230. As can be seen, the notch 230 is located immediately under the buffer air space within the clearance gap 24 between the first vertically-extending weatherstrip 50 and the second vertically-extending weatherstrip 52. The first weatherstrip 232 of the insert 210 (FIG. 8) is in registry with this first vertically-extending weatherstrip 50. The second weatherstrip 234 of the insert 210 intersects the second vertically-extending weatherstrip 52 and also reaches the third weatherstrip 60. The weatherstrips 232, 234 engage the bottom side of the bottom horizontal frame members 70, 200 of the two door panels 14, 16, as best shown in FIG. 7.

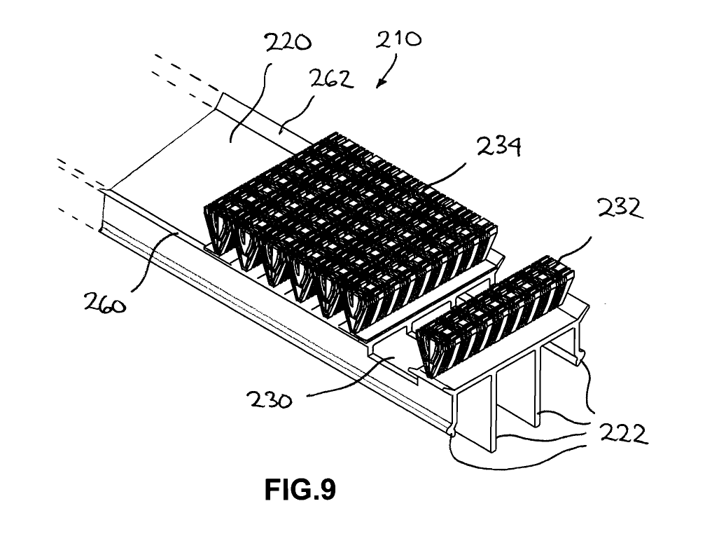

FIG. 9 is an isometric view of the insert 210 shown in FIG. 8. The insert 210 is shown at the end where its notch 230 and its weatherstrips 232, 234 are located. FIG. 9 illustrates the opposite flexible strips 260, 262 obliquely projecting from the longitudinal edges of the main wall 220 of the insert 210. The flexible strips 260, 262 are configured and disposed for engaging the inside of the main section 92 of the gutter 90.

In use, during severe weather conditions, the first set of weatherstrip 50, 232 acts as a baffle to decrease the velocity of air and water entering the clearance gap 24 between the door panels 14, 16. They are continually subjected to a substantially equal air pressure on opposite sides since the buffer air space is in a continual fluid communication with the exterior through the passageway at the bottom. Any water reaching inside the buffer air space is channeled directly into the passageway and kept away from the second set of weatherstrips 52, 234 since water is prevented from passing on the other side of the notch 230 because the notch 230 extends the full width of the main wall 220. Nevertheless, one can use a notch having a smaller width and create a barrier at each end of that notch. The second set of weatherstrip 52, 234 essentially mitigates the air infiltration inside the building.

As can be appreciated, the above-described arrangement can greatly improve watertightness between the door panels 14, 16 during severe weather conditions without the need of a complex arrangement and/or weatherstrips impairing the movement of the sliding door panel 14.

The proposed concept also provides a method of improving weathertightness between a sliding door panel 14 and of a stationary door panel 16 of the patio door assembly 10. The method includes the simultaneous steps of:
blocking at least some of the air and water using a first set of weatherstrips 50, 232 positioned adjacent to an inlet of the vertically-extending clearance gap 24 located between the adjacent vertical frame members 20, 22 of the door panels 14, 16 when the sliding door panel 14 is in a closed position;
maintaining a substantially equal air pressure on opposite sides of the weatherstrips 50, 232 of the first set when a pressure differential occurs between an interior side and an exterior side of the patio door assembly 10; and
draining water toward the exterior side if any water passes through the first set of weatherstrips 50, 232, the water being prevented from reaching a second set of weatherstrips 52, 234 located deeper into the clearance gap 24.

Draining water may include collecting water at the bottom of the air space located in the clearance gap 24 between the first and the second sets of weatherstrips 50, 232, 52, 234.

The present detailed description and the appended figures are meant to be exemplary only, and a skilled person will recognize that changes can be made. The following paragraphs give examples of such changes but they are only a subset of all the possible changes and are presented in no particular order.

As aforesaid, the number of door panels in the patio door assembly is not limited to two. For instance, one can design a patio door assembly with a central stationary door panel and two opposite sliding door panels, one on each side of the stationary door panel. Using more than three door panels is also possible.

The reference to a “slidable” door panel does not exclude the fact that the same door panel can also be otherwise movable within the door frame. For instance, the door panel could also have a tilted position.

The various features of the illustrated examples can be combined differently and the shapes and/or the number of the parts can be different compared to what is shown and described. The proposed concept is not limited to the illustrated examples.

Materials can be different from those specifically mentioned in the present specification.

It should be noted that the word “building” is used herein in a broad generic manner and may possibly cover constructions that are not always necessarily referred to as buildings by some persons. Likewise, the word “exterior” generally designates the side from which water impinges on the patio door assembly. In certain cases, the patio door assembly as suggested herein can be located inside a building.

The bottom drain holes of the gutter can have a shape different than that shown and described.

Still many other variants of the proposed concept will be apparent to a skilled person, in light of a review of the present specification.

What is claimed is:

1. A watertight patio door assembly having an exterior side and an interior side, the patio door assembly including:
a quadrilateral door frame having a sill section, a head section and opposite first and second jamb sections;
two adjacent and laterally offset door panels mounted in the door frame and lying in respective vertical planes that are parallel to one another, at least one of the door panels being slidably movable within the door frame, each door panel including vertical and horizontal frame members, the innermost vertical frame members of the door panels being adjacent to one another and having a clearance gap between them when the patio door assembly is in a closed position;
a combined air and water passageway located within the sill section of the door frame, the passageway providing a continual fluid communication between a location at a bottom end of the clearance gap and the exterior side of the patio door assembly; and
two spaced-apart sets of weatherstrips creating a vertically-extending buffer air space within the clearance gap, the buffer air space being immediately above the location at the bottom end of the clearance gap, a first one of the two sets of weatherstrips being proximal to an exterior edge of the clearance gap and being continually subjected to a substantially equal air pressure on opposite sides, any water reaching inside the buffer air space being channeled directly into the passageway and kept away from a second one of the two sets weatherstrips, which second set is distal from the exterior edge of the clearance gap.

2. The patio door assembly as defined in claim 1, wherein one of the door panels is stationary within the door frame, the other door panel being slidable.

3. The patio door assembly as defined in claim 2, wherein the stationary door panel is closer to the exterior side than the slidable door panel.

4. The patio door assembly as defined in claim 3, wherein each of the two sets of weatherstrips includes a weatherstrip extending transversally under the innermost vertical frame members.

5. The patio door assembly as defined in claim 4, wherein the transversally-extending weatherstrips are substantially horizontally disposed.

6. The patio door assembly as defined in claim 3, wherein each of the two sets of weatherstrips includes a weatherstrip extending vertically, each vertically-extending weatherstrip projecting from one of the innermost vertical frame members to the other innermost vertical frame member.

7. The patio door assembly as defined in claim 2, wherein the passageway includes a bottom horizontal gutter extending longitudinally inside the sill section of the door frame.

8. The patio door assembly as defined in claim 7, wherein the gutter includes a main top-open main section that is positioned transversally between the vertical door planes and that includes a plurality of bottom drain holes that are in fluid communication with at least one outlet drain hole provided on an exterior side of the sill section.

9. The patio door assembly as defined in claim 8, wherein the location at the bottom end of the clearance gap coincides with a notch provided on a main horizontal wall of an elongated insert positioned inside the main section of the gutter, the insert extending substantially all along the stationary door panel.

10. The patio door assembly as defined in claim 9, wherein the notch extends transversally across substantially an entire width of the main horizontal wall of the insert.

11. The patio door assembly as defined in claim 9, wherein the insert includes a plurality of longitudinally-extending and spaced-apart spacer walls projecting from a bottom side of the main horizontal wall of the insert, the spacer walls being configured and disposed to engage an interior of the main section of the gutter.

12. The patio door assembly as defined in claim 9, wherein the insert includes flexible sealing strips extending substantially laterally along longitudinal edges of the main horizontal wall, the sealing strips being configured and disposed to engage an interior of the main section of the gutter.

13. The patio door assembly as defined in claim 9, wherein each of the two sets of weatherstrips includes a weatherstrip located on the main horizontal wall of the insert, the notch being positioned in-between the weatherstrips on the main horizontal wall of the insert.

14. The patio door assembly as defined in claim 13, wherein at least one of the weatherstrips on the main horizontal wall of the insert includes at least one row of upwardly-projecting pile fibers.

15. An insert for use in a main section of a top-opened gutter extending longitudinally inside a sill section of a patio door frame, the insert including:
a first elongated wall having a width substantially corresponding to the width inside of the main section of the gutter, the first wall including a notch made across a thickness of the first wall and extending widthwise adjacent to one end of the insert; and
at least two spaced-apart second elongated walls extending perpendicularly from a first main face of the first wall, at least one of the second walls crossing the notch made through the first wall.

16. The insert as defined in claim 15, further including two weatherstrips extending widthwise on a second main face of the first wall, the notch being located between the weatherstrips.

17. The insert as defined in claim 15, wherein at least one of the weatherstrips includes a row of pile fibers.

18. The insert as defined in claim 15, wherein the first and the second walls are part of a same extruded workpiece.

19. A method for improving watertightness between a sliding door panel and of a stationary door panel of a patio door assembly, the method including the simultaneous steps of:
blocking at least some of the air and water using a first set of weatherstrips positioned adjacent to an inlet of a vertically-extending clearance gap located between adjacent vertical frame members of the door panels when the sliding door panel is in a closed position;
maintaining a substantially equal air pressure on opposite sides of the weatherstrips of the first set when a pressure differential occurs between an interior side and an exterior side of the patio door assembly; and
draining water toward the exterior side if any water passes through the first set of weatherstrips, the water being prevented from reaching a second set of weatherstrips located deeper into the clearance gap.

20. The method as defined in claim 19, wherein the step of draining water includes collecting water at a bottom of an air space located in the clearance gap between the first and the second sets of weatherstrips.
